(19) United States
(12) Patent Application Publication
(10) Pub. No.: US 2023/0120939 A1
(43) Pub. Date: Apr. 20, 2023

(54) COIL COMPONENT

(71) Applicant: SAMSUNG ELECTRO-MECHANICS CO., LTD., Suwon-si (KR)

(72) Inventors: Chan YOON, Suwon-si (KR); Dong Hwan LEE, Suwon-si (KR); Dong Jin LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 17/885,941

(22) Filed: Aug. 11, 2022

(30) Foreign Application Priority Data
Aug. 19, 2021 (KR) 10-2021-0109561

(51) Int. Cl. H01F 27/32; H01F 27/29; H01F 27/24

(52) U.S. Cl. CPC H01F 27/323; H01F 27/29; H01F 27/24

(57) ABSTRACT

A coil component includes a body including first to fourth side surfaces and one surface and the other surface connected to each of the first to fourth side surfaces and opposing each other in a first direction, a distance between the one surface and the other surface in the first direction being 440 μm or less, and a coil disposed in the body, wherein a thickness of the coil in the first direction is shorter than a minimum distance from the one surface of the body to the coil, and a minimum distance from the coil to the first to fourth side surfaces of the body is 40 μm or greater.

### CROSS-REFERENCE TO RELATED APPLICATION

This application claims benefit of priority to Korean Patent Application No. 10-2021-0109561 filed on Aug. 19, 2021 in the Korean Intellectual Property Office, the disclosure of which is incorporated herein by reference in its entirety.

### TECHNICAL FIELD

The present disclosure relates to a coil component.

### BACKGROUND

An inductor, a coil component, is a typical passive electronic component used in electronic devices along with a resistor and a capacitor.

As electronic devices have had higher performance and become smaller, the number of electronic components used in electronic devices has been increased and miniaturized.

In particular, as smartphones have evolved, demand for thin power inductors supporting high current and having high efficiency, high performance, and small size has increased. Accordingly, demand for low profile power inductors is gradually increasing, and it is necessary to respond thereto.

### SUMMARY

An aspect of the present disclosure may provide a coil component that can be mounted on a substrate including a microcircuit pattern.

An aspect of the present disclosure may also provide a coil component capable of reducing an incidence of defective products.

According to an aspect of the present disclosure, a coil component includes a body including first to fourth side surfaces and one surface and the other surface connected to each of the first to fourth side surfaces and opposing each other in a first direction, a distance between the one surface and the other surface in the first direction being 440 μm or less; and a coil disposed in the body, wherein a thickness of the coil in the first direction is shorter than a minimum distance from one surface of the body to the coil, and a minimum distance from the coil to the first to fourth side surfaces of the body is 40 μm or greater.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view schematically illustrating a coil component according to the present disclosure;

FIGS. 2A and 2B are views illustrating cross-sections taken along lines I-I′ and II-II′ of FIG. 1, respectively;

FIG. 3 is a view of the coil component of FIG. 1 viewed from above (in the A direction);

FIGS. 4A and 4B are views schematically illustrating coil components according to the present disclosure;

FIGS. 5A and 5B are views illustrating a cross-section taken along line of FIG. 4A and a cross-section taken along line IV-IV′ of FIG. 4B, respectively;

FIGS. 6A and 6B are views of FIGS. 4A and 4B, respectively, viewed from above (in the B and C directions);

FIG. 7 is a view schematically illustrating a coil component according to the present disclosure;

FIG. 8 is a view illustrating a cross-section taken along line V-V′ of FIG. 7.

FIGS. 9A and 9B are views schematically illustrating coil components according to the present disclosure;

FIGS. 10A and 10B are views illustrating a cross-section taken along line VI-VI′ of FIG. 9A and a cross-section taken along line VII-VII′ of FIG. 9B, respectively; and

FIGS. 11A and 11B are views of FIGS. 9A and 9B, respectively, viewed from above (in the D and E directions).

### DETAILED DESCRIPTION

Exemplary embodiments of the present disclosure will now be described in detail with reference to the accompanying drawings.

In the drawings, an L direction may be defined as a first direction or length direction, a W direction may be defined as a second direction or a width direction, and a T direction may be defined as a third direction or a thickness direction.

Hereinafter, a coil component according to an exemplary embodiment in the present disclosure will be described in detail with reference to the accompanying drawings, and in the description with reference to the accompanying drawings, the same or corresponding components are assigned the same reference numerals, and repeated descriptions thereof will be omitted.

Various types of electronic components are used in electronic devices, and among these electronic components, various types of coil components may be appropriately used for the purpose of removing noise and the like.

That is, in electronic devices, a coil component may be used as a power inductor, a high frequency inductor, a general bead, a high frequency bead (GHz Bead), a common mode filter, etc.

Coil Component and Method for Manufacturing Coil Component

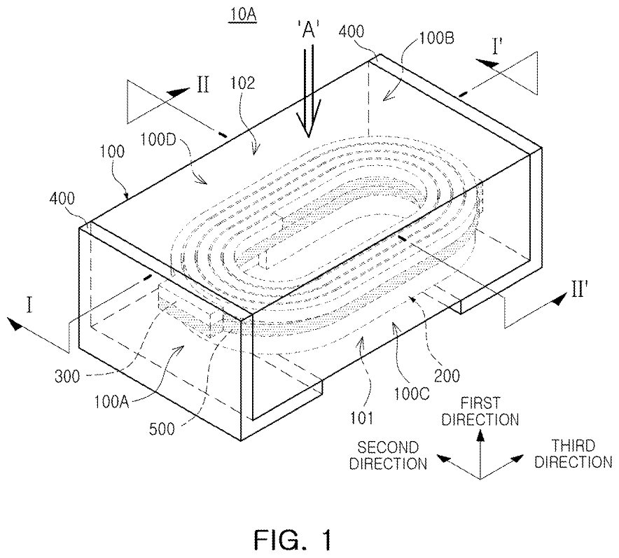

FIG. 1 is a view schematically illustrating a coil component according to the present disclosure.

Referring to the drawings, a coil component 10A according to an exemplary embodiment in the present disclosure may include a body 100 including first to fourth side surfaces 100A, 100B, 100C, and 100D and one surface 101 and the other surface 102 connected to each of the first to fourth side surfaces and opposing each other in the first direction, a coil 200 disposed in the body 100, and a lead portion 300 disposed in the body 100, connected to the coil 200, and having at least a portion exposed to the first side surface 100A of the body.

In this case, the first and second side surfaces 100A and 100B of the body 100 may face each other, and the third and fourth side surfaces 100C and 100D may be disposed to face each other.

Also, the coil 200 may include a coil pattern 210 having at least one turn and an insulating layer 220 covering the coil pattern 210. In this case, the insulating layer 220 may function to insulate the body 100 and the coil pattern 210 from each other, but is not limited thereto.

In addition, the coil component 10A according to the present exemplary embodiment may further include a substrate 500 disposed in the body 100 and allowing the coil 200 to be disposed on one surface thereof. The substrate 500 may be configured to support the coil 200, but is not limited thereto. In this case, the insulating layer 220 of the coil may extend to cover the substrate.

At this time, the coil 200 may be disposed on each of the upper and lower portions of the substrate 500, and may include vias penetrating through the substrate 500 and connecting the coils 200 of the upper and lower portions, respectively, but is not limited thereto.

In addition, the coil component 10A according to this exemplary embodiment may further include an external electrode 400 disposed on at least a portion of the first and second side surfaces 100A and 100B of the body 100 opposing each other and having at least a portion extending to one surface 101 of the body. In this case, at least a portion of the external electrode 400 disposed on at least a portion of the first and second side surfaces 100A and 100B of the body 100 may be in contact with the lead portion 300. In addition, when the substrate 500 supporting the coil 200 is disposed, the external electrode 400 may be further in contact with at least a portion of the substrate 500 exposed to at least a portion of the first and second side surfaces 100A and 100B of the body.

Also, although not shown, in the coil component 10A according to the present exemplary embodiment, an insulating film may be additionally disposed on the other surface 102 and the third and fourth side surfaces 100C and 100D of the body 100 opposing each other, and the insulating layer may be formed to extend to a region of one surface 101 of the body in which the external electrode 400 is not disposed.

The body 100 forms the exterior of the coil component 10A according to the present exemplary embodiment, and the coil 200 is embedded therein. The body 100 may be formed in a hexahedral shape as a whole.

The body 100 may include a magnetic material and an insulating resin. Specifically, the body 100 may be formed by laminating one or more magnetic composite sheets including an insulating resin and a magnetic material dispersed in the insulating resin. However, the body 100 may have a structure other than the structure in which a magnetic material is dispersed in an insulating resin. For example, the body 100 may be formed of a magnetic material such as ferrite.

The magnetic material may be ferrite or metallic magnetic powder.

Ferrite powder may be at least one of, for example, spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrites such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, and Li-based ferrite.

Metal magnetic powder may include at least any one selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder may be at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si alloy powder, Fe—Si—Cu—Nb-based alloy powder, Fe—Ni—Cr-based alloy powder, and Fe—Cr—Al-based alloy powder.

The metal magnetic powder may be amorphous or crystalline. For example, the metal magnetic powder may be Fe—Si—B—Cr-based amorphous alloy powder, but is not limited thereto.

Ferrite and the metal magnetic powder may have an average diameter of about 0.1 μm to 30 μm, but is not limited thereto.

The body 100 may include two or more types of magnetic materials dispersed in a resin. Here, the different types of magnetic materials refer to that magnetic materials dispersed in an insulating resin are distinguished from each other by any one of an average diameter, a composition, crystallinity, and a shape.

The insulating resin may include, but is not limited to, epoxy, polyimide, liquid crystal polymer, or the like alone or in combination.

The coil 200 may be embedded in the body 100. The coil component according to the present disclosure exhibits its characteristics from the coil 200. For example, when the coil component of the present exemplary embodiment is used as a power inductor, the coil 200 may serve to stabilize power of the electronic device by maintaining an output voltage by storing an electric field as a magnetic field. Here, the coil 200 is not limited to a thin-film coil, but may correspond to a winding-type coil or a laminated-type coil.

Each of the coil 200, the lead portion 300, and the via may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

The substrate 500 may be formed of an insulating material including a thermosetting insulating resin such as an epoxy resin, a thermoplastic insulating resin such as polyimide, or a photosensitive insulating resin, or may be formed of an insulating material formed by impregnating an insulating resin with a reinforcing material such as glass fiber or an inorganic filler. For example, the substrate 500 may be formed of an insulating material such as a copper clad laminate (CCL), unclad CCL, prepreg, Ajinomoto build-up film (ABF), FR-4, bismaleimide triazine (BT) film, photo imagable dielectric (PID) film, but the present disclosure is not limited thereto.

As an inorganic filler, at least one selected from the group consisting of silica (SiO₂), alumina (Al₂O₃), silicon carbide (SiC), barium sulfate (BaSO4), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the substrate 500 is formed of an insulating material including a reinforcing material, the substrate 500 may provide more excellent rigidity. When the substrate 500 is formed of an insulating material not including glass fibers, a volume of the coil 200 may be increased within the same size of the body 100.

When the substrate 500 is formed of an insulating material including a photosensitive insulating resin, the number of processes for forming the coil 200 may be reduced, advantageously reducing production costs and forming fine vias.

A metal included in the external electrode 400 may be formed of two or more alloys selected from among tin (Sn), lead (Pb), indium (In), copper (Cu), silver (Ag), and bismuth (Bi).

The external electrode 400 may be formed by applying a conductive resin paste or may be formed by plating a material including the metal material, but is not limited thereto.

The insulating layer 220 of the coil 200 may be formed by at least one of a vapor deposition method and a film lamination method. Meanwhile, in the latter case, the insulating layer 220 may be a permanent resist in which a plating resist used in plating the coil 200 on the substrate 500 remains in a final product, but the present disclosure is not limited thereto.

In addition, the external electrode 400 may further include a plating layer. In this case, the plating layer may include a conductive material. The plating layer may be electrically connected to a solder, which is a connection conductor. In this case, the plating layer may include nickel (Ni) or tin (Sn), and may have a structure in which a nickel (Ni) plating layer and a tin (Sn) plating layer are sequentially laminated. When the external electrode is a conductive resin layer, the nickel (Ni) plating layer is in contact with a conductive connection portion of a conductive resin layer inside the external electrode 400 and the base resin.

The coil component 10A according to this exemplary embodiment may satisfy at least one of a first condition (T1≤0.44 mm) in which a distance T1 of the body 100 in the first direction is 440 μm or less, a second condition (T2>T3) in which a distance T3 in the first direction is less than a minimum distance T2 from one surface 101 of the body 100 to the coil 200 in the first direction, a third condition (Min{ML, MW} ≥40 μm) in which a minimum distance M to the first to fourth sides 100A, 100B, 100C, and 100D of the body 100 has a value of 40 μm or greater, and a fourth condition (T2≥70 μm) in which a minimum distance T2 from one surface 101 to the coil 200 in the first direction has a value of 70 μm or greater, but the present disclosure is not limited thereto.

A meaning and a measurement method of each of the distance T1 of the body 100 in the first direction, the minimum distance T2 from one surface 101 of the body 100 to the coil 200 in the first direction, and the distance T3 of the coil 200 in the first direction will be described in detail below.

Referring to the experimental data below, when the body thickness T1 of the coil component 10A exceeds 440 μm, a product defect may occur even if the minimum distance M from the coil 200 to the first to fourth side surfaces 100A, 100B, 100C and 100D of the body 100 has a value of 40 μm or greater.

In addition, when the distance T3 of the coil 200 in the first direction is formed to be longer than the minimum distance T2 from one surface of the body 100 to the coil 200 in the first direction, a possibility of product defect occurrence may be increased, even if the minimum distance M from the coil 200 to the second to fourth side surfaces 100A, 100B, 100C, and 100D of the body 100 has a value of 40 μm or greater.

In addition, when the minimum distance M to the first to fourth side surfaces 100A, 100B, 100C, and 100D of the body 100 has a value less than 40 μm, the possibility of product defects may increase, regardless of the distance T1 of the body 100 in the first direction, the minimum distance T2 from one surface of the body 100 to the coil 200 in the first direction, and the distance T3 of the coil 200 in the first direction.

Accordingly, the coil component 10A according to the present exemplary embodiment may be formed to satisfy all of the first to third conditions. That is, the distance T1 of the body 100 in the first direction is 440 μm or less, the distance T3 of the coil 200 in the first direction is less than the minimum distance T2 in the first direction from the one surface 101 of the body 100 to the coil 200, and the minimum distance M to the second to fourth side surfaces 100A, 100B, 100C, and 100D of the body 100 has a value of 40 μm or greater, but the present disclosure is not limited thereto.

TABLE 1

| Tchip [mm] | 0.6 | | | | | | | | | | | | | | | | | | | | | | | |
|---|---|---|---|---|---|---|---|---|---|---|---|---|---|---|---|---|---|---|---|---|---|---|---|---|
| T1 [mm] | 0.54 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | 130 | | | 140 | | | 150 | | | 160 | | | 170 | | | 180 | | | 180 | | | 200 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | 5 | 4 | 0 | 8 | 2 | 0 | 10 | 1 | 0 | 30 | 26 | 24 | 41 | 37 | 32 | 90 | 83 | 76 | 94 | 92 | 84 | 95 | 92 | 90 |
| Chipping | | | | | | | | | | | | | | | | | | | | | | | | |
| Tchip [mm] | 0.5 | | | | | | | | | | | | | | | | | | | | | | | |
| T1 [mm] | 0.44 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | 80 | | | 90 | | | 100 | | | 110 | | | 120 | | | 130 | | | 140 | | | 150 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | 4 | 0 | 0 | 8 | 0 | 0 | 9 | 0 | 0 | 28 | 24 | 22 | 40 | 35 | 24 | 88 | 82 | 72 | 91 | 80 | 79 | 92 | 90 | 83 |
| Chipping | | | | | | | | | | | | | | | | | | | | | | | | |
| Tchip [mm] | 0.45 | | | | | | | | | | | | | | | | | | | | | | | |
| T1 [mm] | 0.39 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | 55 | | | 65 | | | 75 | | | 85 | | | 95 | | | 105 | | | 115 | | | 125 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | 4 | 0 | 0 | 7 | 0 | 0 | 8 | 0 | 0 | 11 | 0 | 0 | 39 | 33 | 23 | 82 | 77 | 36 | 84 | 78 | 52 | 90 | 80 | 78 |
| Chipping | | | | | | | | | | | | | | | | | | | | | | | | |
| Tchip [mm] | 0.4 | | | | | | | | | | | | | | | | | | | | | | | |
| T1 [mm] | 0.34 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | 30 | | | 40 | | | 50 | | | 60 | | | 70 | | | 80 | | | 90 | | | 100 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | 4 | 0 | 0 | 6 | 0 | 0 | 8 | 0 | 0 | 10 | 0 | 0 | 14 | 0 | 0 | 75 | 55 | 35 | 78 | 65 | 50 | 90 | 79 | 77 |
| Chipping | | | | | | | | | | | | | | | | | | | | | | | | |
| Tchip [mm] | 0.35 | | | | | | | | | | | | | | | | | | | | | | | |
| T1 [mm] | 0.29 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | 5 | | | 15 | | | 25 | | | 35 | | | 45 | | | 55 | | | 65 | | | 75 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | 4 | 0 | 0 | 5 | 0 | 0 | 8 | 0 | 0 | 9 | 0 | 0 | 13 | 0 | 0 | 24 | 0 | 0 | 33 | 0 | 0 | 80 | 78 | 76 |
| Chipping | | | | | | | | | | | | | | | | | | | | | | | | |

As shown in Table 1 above, by manufacturing a small and thin inductor, a coil component that may be mounted on a substrate including a microcircuit pattern may be provided and the incidence of defective products when manufacturing a small-sized inductor may also be reduced.

In addition, referring to the experimental data of Table 2 below, the minimum distance T2 from the one surface 101 of the body to the coil 200 in the first direction, that is, the thickness of the cover portion may be 70 μm or more.

If the minimum distance T2 from the one surface 101 of the body to the coil 200 in the first direction has a value less than 70 μm, product defects may occur even if the distance T1 of the body 100 in the first direction is formed to be 440 μm or less, the distance T3 of the coil 200 in the first direction is formed to be less than the minimum distance T2 from the one surface 101 of the body 100 to the coil 200 in the first direction, and the minimum distance M to the first to fourth side surfaces 100A, 100B, 100C, and 100D of the body 100 has a value of 40 μm or greater.

Therefore, in the coil component 10A according to the present exemplary embodiment, the minimum distance T2 from the one surface 101 of the body to the coil 200 in the first direction is formed to have a value of 70 μm or greater, so that all of the first to fourth conditions may be satisfied, but the present disclosure is not limited thereto.

TABLE 2

| Tchip [mm] | 0.3 | | | | | | | | | | | | | | | | | | | | | | | |
|---|---|---|---|---|---|---|---|---|---|---|---|---|---|---|---|---|---|---|---|---|---|---|---|---|
| T1 [mm] | 0.24 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | N/A | | | N/A | | | N/A | | | 10 | | | 20 | | | 30 | | | 40 | | | 50 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | | | | | | | | | | 8 | 0 | 0 | 10 | 0 | 0 | 20 | 0 | 0 | 27 | 0 | 0 | 75 | 73 | 72 |
| Chipping | | | | | | | | | | | | | | | | | | | | | | | | |
| Tchip [mm] | 0.25 | | | | | | | | | | | | | | | | | | | | | | | |
| T1 [mm] | 0.19 | | | | | | | | | | | | | | | | | | | | | | | |
| T5 [μm] | 20 | | | | | | | | | | | | | | | | | | | | | | | |
| T2 [μm] | 130 | | | 120 | | | 110 | | | 100 | | | 90 | | | 80 | | | 70 | | | 60 | | |
| T3l [μm] | N/A | | | N/A | | | N/A | | | N/A | | | N/A | | | 5 | | | 15 | | | 25 | | |
| M [μm] | 30 | 40 | 50 | 30 | 40 | 50 | 30 | 40 | 50 | 30 | 40 | 50 | 30 | 40 | 50 | 30 | 40 | 50 | 30 | 40 | 50 | 30 | 40 | 50 |
| # of | | | | | | | | | | | | | | | | 17 | 0 | 0 | 25 | 0 | 0 | 73 | 72 | 70 |
| Chipping | | | | | | | | | | | | | | | | | | | | | | | | |

As shown in Table 2 above, by manufacturing a small and thin inductor, a coil component that may be mounted on a substrate including a microcircuit pattern may be provided, and the incidence of defective products when manufacturing a small-sized inductor may also be reduced.

“# of Chipping” refers to the number of chipped chips among 100 chips manufactured to have the same parameters listed in the tables above. The presence of chipping was observed using a scanning electron microscope.

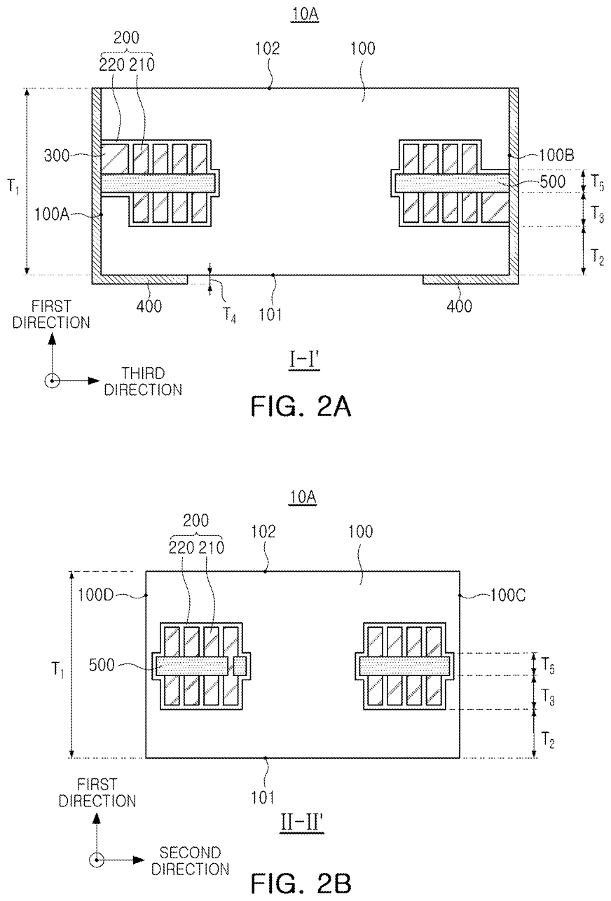

FIGS. 2A and 2B are views illustrating cross-sections taken along lines I-I′ and II-II′ of FIG. 1, respectively.

Referring to the drawings, in the coil component 10A according to the present exemplary embodiment, the distance T1 from one surface 101 to the other surface 102 of the body 100 in the first direction opposing each other in the first direction may be 440 μm or less. That is, a body thickness of the coil component 10A according to the present exemplary embodiment may be 440 μm or less, but is not limited thereto.

In addition, in the coil component 10A according to the present exemplary embodiment, the distance T3 of the coil 200 in the first direction may be formed to be less than the minimum distance T2 from the one surface 101 of the body 100 to the coil 200 in the first direction. That is, the thickness of the cover portion T2, which is the thickness of the body 100 covering the coil, may be thicker than the thickness of the coil 200 of the coil component 10A according to the present exemplary embodiment (T2>T3), but the present disclosure is not limited thereto.

In addition, at this time, the minimum distance T2 from the one surface 101 of the body to the coil 200 in the first direction, that is, the thickness of the cover portion, may be 70 μm or greater (T2≥70 μm), but the present disclosure is not limited thereto.

In addition, in the coil component 10A according to the present exemplary embodiment, the distance T4 of the external electrode 400 disposed on the one surface 101 of the body in the first direction may be 60 μm or less. That is, the thickness of the external electrode 400 may be 60 μm or less (T4≤60 μm), but is not limited thereto.

In addition, in the coil component 10A according to the present exemplary embodiment, the distance T5 of the substrate 500 in the first direction may be 20 μm or less. That is, the thickness of the substrate 500 may be 20 μm or less (T5≤20 μm), but is not limited thereto.

A method of measuring each of the distance T1 from one surface 101 to the other surface 102 of the body 100 in the first direction, the minimum distance T2 from the one surface 101 of the body 100 to the coil 200 in the first distance, the distance T3 of the coil 200 in the first direction, the distance T4 of the external electrode 400 disposed on one surface 101 of the body in the first direction, and the distance T5 of the substrate 500 in the first direction is as follows.

In the present disclosure, the first direction may refer to a thickness direction or a T direction, and the distance in the first direction may refer to a thickness.

In order to derive the measurement values described above, an arbitrary point of the coil component in the second direction (width direction, W direction) is cut in first and third directions (thickness T direction, length L direction) so that the coil 200 of the coil component 10A according to the present exemplary embodiment may be exposed. In this case, a cross-section as shown in FIG. 2A may be exposed, but the present disclosure is not limited thereto.

First, the value of the distance measured in the first direction between the upper and lower portions opposing in the first direction (thickness direction) in the cut surface may correspond to the distance T1 from one surface 101 to the other surface 102 of the body 100 in the first direction. In this case, the upper and lower portions of the cut surface opposing each other in the first direction may correspond to one surface 101 and the other surface 102 of the body 100 of the coil component 10A according to the present exemplary embodiment.

In addition, at this time, the measurement value of the distance T1 from one surface 101 to the other surface 102 of the body 100 in the first direction may correspond to an arithmetic mean value of values obtained by measuring the distance T1 between the upper portion and lower portion 101 and 102 of the cut surface opposing each other in the first direction a plurality of times.

At this time, the measurement value or the mean value may be derived by selecting an arbitrary point of the cut surface in the third direction and then measuring a distance of the upper portion and the lower portion 101 and 102 of the body 100 in the first direction a plurality of times. At this time, the arithmetic mean value of the plurality of measurement values may correspond to the distance T1 from one surface 101 to the other surface 102 of the body 100 in the first direction or a measured thickness value or a mean value of the body 100, but the present disclosure is not limited thereto.

In addition, on the cut surface, a plurality of arbitrary points in the third direction may be measured one or more times. More specifically, after cutting the coil component 10A according to the present exemplary embodiment in the third direction, a plurality of arbitrary points may be selected in the third direction, and the distance of the upper portion and lower portion 101 and 102 of the body 100 in the first direction may be measured a plurality of times for each of the plurality of arbitrary points. At this time, the arithmetic mean value of the plurality of measurement values may correspond to the distance T1 from one surface 101 to the other surface 102 of the body 100, the measured thickness value of the body 100, or the mean value, but the present disclosure is not limited thereto.

Second, in the cut surface, the minimum distance T2 from the lower surface or one surface 101 of the body 100 to the coil 200 in the first direction is measured. At this time, as described above, the coil 200 may include at least one coil pattern 210 and an insulating layer 220, and the minimum distance T2 from the lower surface or one surface 101 of the body 100 to the coil 200 in the first direction may correspond to a minimum distance from the lower surface or one surface 101 of the body to the insulating layer 220 of the coil in the first direction, but the present disclosure is not limited thereto.

At this time, the minimum distance T2 from the lower surface or one surface 101 of the body 100 to the coil 200 in the first direction may refer to a shortest value among values obtained by measuring the distance from the lower surface or one surface 101 of the body 100 to the coil 200 or the insulating layer 220 of the coil at a plurality of arbitrary points in the third direction (length L direction).

Third, the distance T3 of the coil 200 in the first direction is measured. In this case, the measurement value of the distance of the coil 200 T3 in the first direction may correspond to an arithmetic mean value of values obtained by measuring the distance of the coil 200 exposed to the cut surface in the first direction a plurality of times.

In this case, the coil 200 may include the coil pattern 210 including at least one turn and the insulating layer 220, and the distance T3 of the coil 200 in the first direction is measured. In this case, the measurement value of the distance T3 of the coil 200 in the first direction may correspond to a value including the insulating layer 220, but the present disclosure is not limited thereto.

At this time, the measurement value or the mean value may be derived by selecting an arbitrary point of the coil in the cut surface in the third direction and then measuring a distance of the upper end and the lower end of one coil pattern 210 or the insulating layer 220 in the first direction a plurality of times. When the coil component 10A according to the present exemplary embodiment includes the substrate 500, the measurement value or mean value may be a measurement value of the distance from an end portion of the coil pattern 210 of the coil 200 in contact with the substrate to an end of the insulating layer 220 of the coil 200 opposing the end portion in the first direction in the first direction.

In this case, the arithmetic mean value of the plurality of measurement values may correspond to the measurement value or the mean value of the distance T3 of the coil 200 in the first direction, but is not limited thereto.

In addition, on the cut surface, a plurality of arbitrary points in the third direction may be measured one or more times. More specifically, after cutting the coil component 10A according to the present exemplary embodiment in the third direction, a plurality of arbitrary points in the at least one coil pattern 210 of the coil 200 in the third direction may be selected, and a distance of the coil 200 in the first direction may be measured a plurality of times for each of the plurality of arbitrary points. In this case, the arithmetic mean value of the plurality of measurement values may correspond to a distance of the coil 200 in the first direction or a thickness measurement value or mean value of the coil 200, but the present disclosure is not limited thereto.

Fourth, the distance T4 of the external electrode 400 disposed on the one surface 101 of the body in the first direction is measured.

In this case, the distance of the external electrode 400 disposed on the surface 101 of the body in the first direction or the thickness of the external electrode 400 may correspond to a thickness including a plating layer, but the present disclosure is not limited thereto.

In this case, the measurement value of the distance T4 of the external electrode 400 disposed on the one surface 101 of the body in the first direction may correspond to an arithmetic mean value of values obtained by measuring the distance of ends of upper and lower portions of the external electrode 400 exposed to the cut surface of the coil component 10A in the first direction a plurality of times.

In this case, the measurement value or the mean value may be derived by selecting an arbitrary point of the external electrode 400 in the third direction from the cut surface and then measuring the distance of the upper and lower ends in the first direction a plurality of times.

In this case, the arithmetic mean value of the plurality of measurement values may correspond to the distance T4 of the external electrode 400 disposed on one surface 101 of the body in the first direction or the thickness measurement value or the mean value of the external electrode 400, but the present disclosure is not limited thereto.

In addition, on the cut surface, a plurality of arbitrary points in the third direction may be measured one or more times. More specifically, after cutting the coil component 10A according to the present exemplary embodiment in the third direction, a plurality of arbitrary points of the external electrodes 400 in the third direction may be selected, and the distance of the upper and lower ends of the external electrode 400 may be measured a plurality of times for each of the plurality of arbitrary points. In this case, the arithmetic mean value of the plurality of measurement values may correspond to the distance T4 of the external electrode 400 in the first direction or the thickness measurement value or mean value of the external electrode 400, but is not limited thereto.

Finally, the distance T5 of the substrate 500 in the first direction is measured. In this case, when the substrate 500 includes an insulating layer, the distance T5 of the substrate 500 including the insulating layer in the first direction or the thickness of the substrate may be measured, but the present disclosure is not limited thereto.

At this time, the measurement value of the distance T5 of the substrate 500 in the first direction may correspond to an arithmetic mean value of values obtained by measuring the distance of the upper and lower ends of the substrate 500 exposed to the cut surface of the coil component 10A in the first direction a plurality of times.

At this time, the measurement value or the mean value may be derived by selecting an arbitrary point of the substrate 500 from the cut surface in the third direction and then measuring the distance of the upper and lower ends in the first direction a plurality of times.

In this case, the arithmetic mean value of the plurality of measurement values may correspond to the distance T5 of the substrate 500 in the first direction or the thickness measurement value or mean value of the substrate 500, but is not limited thereto.

In addition, on the cut surface, a plurality of arbitrary points in the third direction may be measured one or more times. More specifically, after cutting the coil component 10A according to the present exemplary embodiment in the third direction, a plurality of arbitrary points of the substrate 500 in the third direction may be selected, and the distance of the upper and lower ends of the substrate 500 in the first direction may be measured a plurality of times for each of the plurality of arbitrary points. In this case, the arithmetic mean value of the plurality of measurement values may correspond to the distance T5 of the substrate 500 in the first direction or the thickness measurement value or mean value of the substrate 500, but is not limited thereto.

Meanwhile, numerical values of the length, width, and thickness of the coil component 10A described above exclude tolerance, and an actual length, width, and thickness of the coil component may be different from the values described above due to the tolerance.

By manufacturing the small and thin inductor as described above, a coil component that may be mounted on a substrate including a microcircuit pattern may be provided, and the incidence of defective products when manufacturing the small-sized inductor may also be reduced.

Other components are substantially the same as those described above, and thus, detailed descriptions thereof will be omitted.

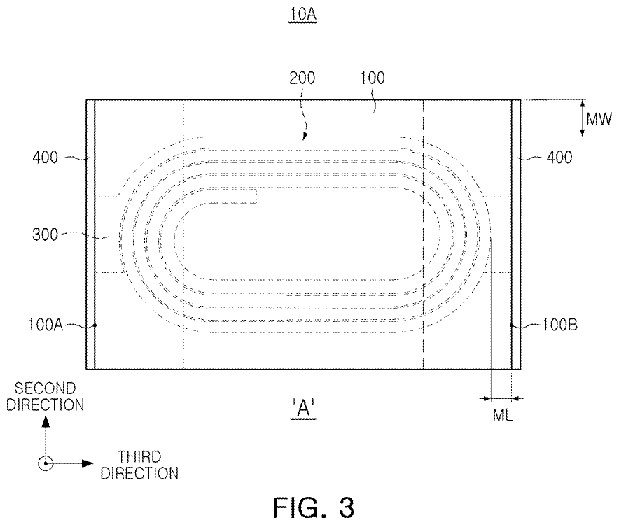

FIG. 3 is a view of the coil component of FIG. 1, viewed from above (direction A).

In the coil component 10A according to this exemplary embodiment, the minimum distance M from the coil 200 to the first to fourth side surfaces 100A, 100B, 100C, and 100D of the body 100 may be 40 μm or greater, but is not limited thereto.

The minimum distance M from the coil 200 to the first to fourth side surfaces 100A, 100B, 100C, and 100D of the body 100 may refer to a margin of the coil component 10A according to the present exemplary embodiment.

In this case, the margin of the coil component may refer to the shortest value among the distances from the first to fourth side surfaces 100A, 100B, 100C, and 100D of the body 100 to the coil 200.

In addition, the lead portion 300 may be exposed through the first side surface 100A of the body 100, and in this case, the shortest value, among the distances from the second to fourth side surfaces 100B, 100C, and 100D of the body, excluding the first side surface 100A of the body to which the lead portion 300 is exposed, may correspond to the margin M of the coil component 10A according to the present exemplary embodiment but the present disclosure is not limited thereto.

A method of measuring the minimum distance M from the coil 200 to the first to fourth side surfaces 100A, 100B, 100C, and 100D of the body 100 or the margin of the coil component 10A according to the present exemplary embodiment is as follows.

In order to derive the measurement values described above, an arbitrary point of the coil component in the first direction (thickness T direction) is cut in the second and third directions (the width W direction and length L direction) so that the coil 200 of the coil component 10A according to the present exemplary embodiment is exposed. At this time, the cross-section as shown in FIG. 3 may be exposed, but the present disclosure is not limited thereto.

Referring to the cut surface, the coil 200 may include the coil pattern 210 having at least one turn and an insulating layer 220, and the minimum distance M from the coil 200 to the first to fourth side surfaces 100A, 100B, 100C, and 100D may correspond to a minimum distance from the first to fourth side surfaces 100A, 100B, 100C, and 100D of the body, but the present disclosure is not limited thereto.

The minimum distance M from the coil 200 to the first to fourth side surfaces 100A, 100B, 100C, and 100D of the body 100 may be a smaller value among the distance ML from the first and second side surfaces 100A and 100B of the body 100 to which the lead portion 300 is exposed to the coil 200 or the insulating layer 220 of the coil in the third direction (the L direction) and the distance MW from the third and fourth side surfaces 100C and 100D of the body 100 opposing each other to the coil 200 or the insulating layer 220 of the coil in the second direction (the W direction), but the present disclosure is not limited thereto.

In addition, when the lead portion 300 is exposed to the first side surface 100A of the body 100, the shortest value, among distances from the second to fourth side surfaces 100B, 100C, and 100D of the body 100 to the coil 200, excluding the first side surface 100A of the body to which the lead portion 300 is exposed, may correspond to the minimum distance M to the first to fourth side surfaces 100A, 100B, 100C, and 100D of the body 100 or the margin M of the coil component 10A according to the present exemplary embodiment.

In addition, the measurement value of the distance M from the coil 200 to the first to fourth side surfaces 100A, 100B, 100C, and 100D of the body 100 may correspond to an arithmetic mean value of values obtained by measuring the distance M from the coil 200 to the first to fourth side surfaces 100A, 100B, 100C, and 100D a plurality of times, but the present disclosure is not limited thereto.

At this time, the measurement value or the mean value may be derived by selecting an arbitrary point of the first to fourth side surfaces 100A, 100B, 100C, and 100D of the body 100 on the cut surface and then measuring distances to the coil 200 or the insulating layer 220 of the coil a plurality of times. At this time, the arithmetic mean value of the plurality of measurement values may correspond to the distance M from the coil 200 to the first to fourth side surfaces 100A, 100B, 100C, and 100D of the body 100 or a margin measurement value or a mean value of the coil component 10A according to the present exemplary embodiment, but the present disclosure is not limited thereto.

In addition, in the cut surface, a plurality of arbitrary points in the first to fourth side surfaces 100A, 100B, 100C, and 100D of the body 100 may be measured at least once. More specifically, after cutting the coil component 10A according to the present exemplary embodiment, a plurality of arbitrary points in the second to fourth side surfaces 100B, 100C, and 100D of the body 100 may be selected, and distances to the coil 200 or the insulating layer 220 of the coil may be measured a plurality of times for each of the plurality of arbitrary points. At this time, the arithmetic mean value of the plurality of measurement values may correspond to the distance M from the coil 200 to the first to fourth side surfaces 100A, 100B, 100C, and 100D of the body 100 or the margin measurement value of the mean value of the coil component 10A according to the present exemplary embodiment, but the present disclosure is not limited thereto.

Meanwhile, the numerical values of the length, width, and thickness described above exclude tolerance, and an actual length, width, and thickness of the coil component may be different from the values described above due to the tolerance.

Other components are substantially the same as those described above, and thus, detailed descriptions thereof will be omitted.

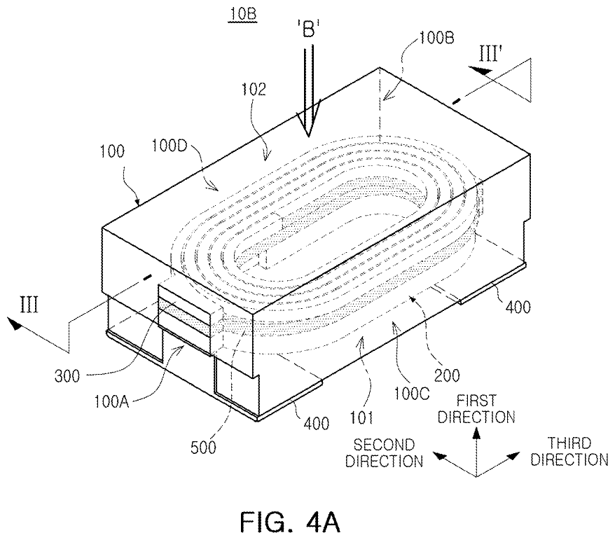

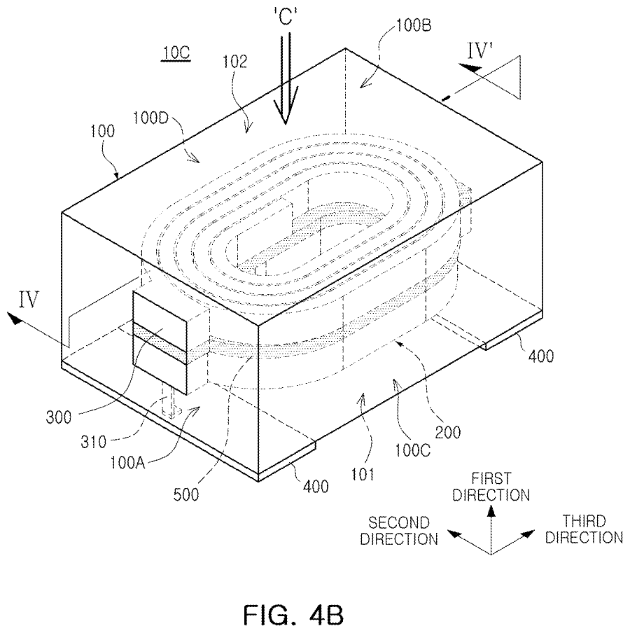

FIGS. 4A and 4B are views schematically illustrating coil components according to the present disclosure.

Referring to the drawings, the coil components 10B and 10C according to an exemplary embodiment in the present disclosure may include a body 100 including first to fourth side surfaces 100A, 100B, 100C, and 100D and one surface 101 and the other surface 102 connected to each of the first to fourth side surfaces 100A, 100B, 100C, and 100D and opposing each other in the first direction, a coil 200 disposed in the body 100, and a lead portion 300 disposed in the body 100, connected to the coil 200, and having at least a portion exposed to the first side surface 100A of the body.

In this case, the first and second side surfaces 100A and 100B of the body 100 may face each other, and the third and fourth side surfaces 100C and 100D may be disposed to face each other.

Also, the coil 200 may include a coil pattern 210 having at least one turn and an insulating layer 220 covering the coil pattern. In this case, the insulating layer 220 may function to insulate the body 100 and the coil 200 from each other, but the present disclosure is not limited thereto.

In addition, the coil components 10B and 10C according to the present exemplary embodiment may further include a substrate 500 disposed in the body 100 and allowing the coil 200 to be disposed on one surface thereof. The substrate 500 may be configured to support the coil 200, but is not limited thereto.

In this case, the coil 200 may be disposed on each of the upper and lower portions of the substrate 500, and a via penetrating through the substrate 500 to connect the coils of the upper and lower portions may be included, but is not limited thereto.

Referring to the drawings, the coil components 10B and 10C according to the present exemplary embodiment may include an external electrode 400 on one surface 101 of a body 100, and the external electrode 400 may include first and second external electrodes 400A and 400B spaced apart from each other on one surface 101 of the body.

At this time, the lead portion 300 may be in direct contact with at least a portion of the first and second external electrodes 400A and 400B as shown in FIG. 4A, and may include a connection portion 310 connected to each of the second external electrodes 400A and 400B as shown in FIG. 4B.

Also, although not shown, in the coil components 10B and 10C according to the present exemplary embodiment, an insulating film may be additionally disposed on each of the first to fourth side surfaces 100A, 100B, 100C, and 100D of the body 100, but the present disclosure is not limited thereto. That is, the external electrode 400 may be disposed only on one surface 101 of the body 100. In addition, when the external electrode 400 extends from one surface 101 of the body 100 to the first to fourth side surfaces 100A, 100B, 100C, and 100D, an insulating film may be additionally disposed on the four side surfaces 100A, 100B, 100C, and 100D of the body 100, but the present disclosure is not limited thereto.

In addition, in the coil components 10B and 10C according to the present exemplary embodiment, the distance T1 of the body 100 in the first direction may be 440 μm or less, the distance T3 of the coil 200 in the first direction is less than the minimum distance T2 from one surface 101 of the body 100 to the coil 200 in the first direction, and the minimum distance M to the first to fourth side surfaces 100A, 100B, 100C, and 100D of the body 100 may have a value of 40 μm or greater, but the present disclosure is not limited thereto.

In addition, in the coil components 10B and 10C according to the present exemplary embodiment, the minimum distance T2 from one surface 101 of the body to the coil 200 in the first direction has a value of 70 μm or greater, but the present disclosure is not limited thereto.

Other components are substantially the same as those described above, and thus, detailed descriptions thereof will be omitted.

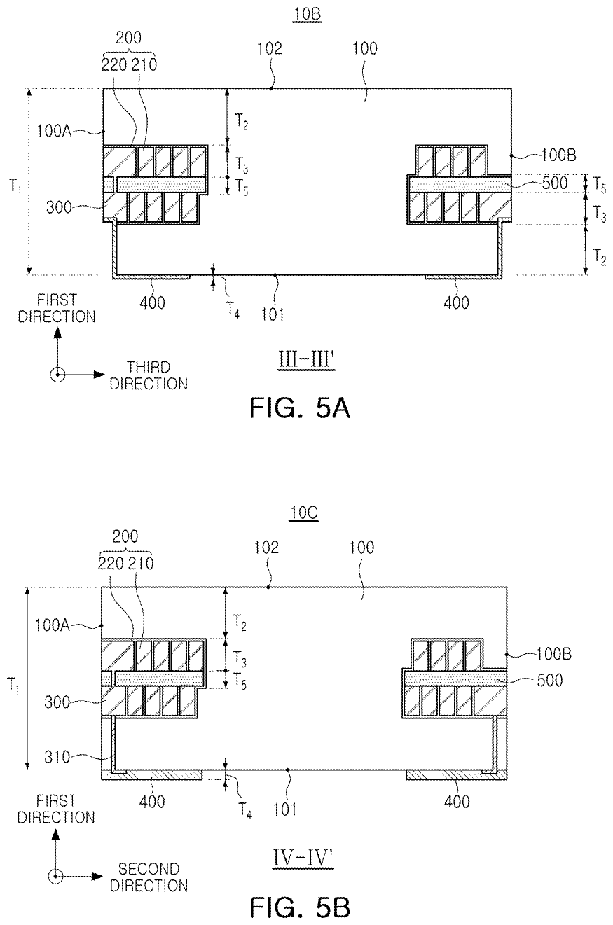

FIGS. 5A and 5B are views illustrating a cross-section taken along line of FIG. 4A and a cross-section taken along line IV-IV′ of FIG. 4B, respectively.

Referring to the drawings, in the coil components 10B and 10C according to the present exemplary embodiment, the distance T1 from one surface 101 to the other surface 102 of the body in the first direction opposing each other in the first direction may be 440 μm or less. That is, a body thickness of the coil component 10B according to the present exemplary embodiment may be 440 μm or less, but is not limited thereto.

In addition, in the coil components 10B and 10C according to the present exemplary embodiment, the distance T3 of the coil 200 in the first direction may be less than the minimum distance T2 from one surface 101 of the body 100 to the coil 200 in the first direction. That is, a thickness of a cover portion, which is a thickness of the body covering the coil, may be thicker than the thickness of the coil 200 of the coil component 10B according to the present exemplary embodiment, but the present disclosure is not limited thereto. At this time, the minimum distance T2 from one surface 101 of the body to the coil 200 in the first direction, that is, the thickness of the cover portion, may be 70 μm or greater, but the present disclosure is not limited thereto.

In addition, in the coil components 10B and 10C according to the present exemplary embodiment, a distance T4 of the external electrode 400 disposed on one surface 101 of the body in the first direction may be 60 μm or less. That is, the thickness of the external electrode 400 may be 60 μm or less, but is not limited thereto. In this case, the external electrode 400 may include first and second external electrodes 400A and 400B spaced apart from each other on one surface 101 of the body, and a distance or thickness of each of the first and second external electrodes 400A and 400B in the first direction may be 60 μm or less, but is not limited thereto.

In addition, in the coil components 10B and 10C according to the present exemplary embodiment, a distance T5 of the substrate 500 in the first direction may be 20 μm or less. That is, the thickness of the substrate 500 may be 20 μm or less, but is not limited thereto.

A method of measuring each of the distance T1 from one surface 101 to the other surface 102 of the body 100 in the first direction, the minimum distance T2 from one surface 101 of the body 100 to the coil 200 in the first distance, the distance T3 of the coil 200 in the first direction, the distance T4 of the external electrode 400 disposed on one surface 101 of the body in the first direction, and the distance T5 of the substrate 500 in the first direction is as described above.

Other components are substantially the same as those described above, and thus, detailed descriptions thereof will be omitted.

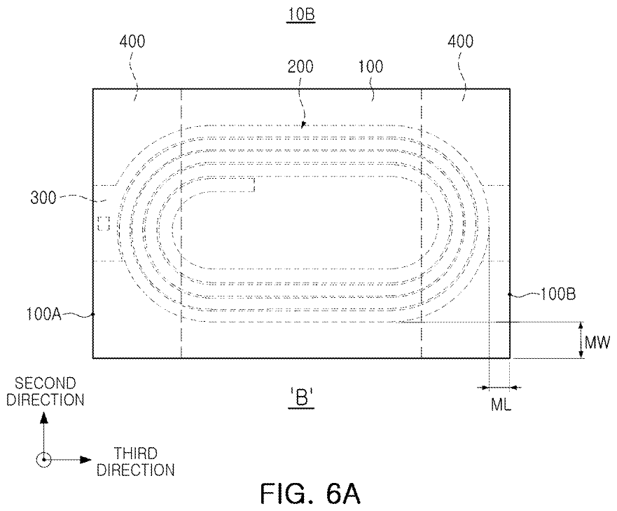

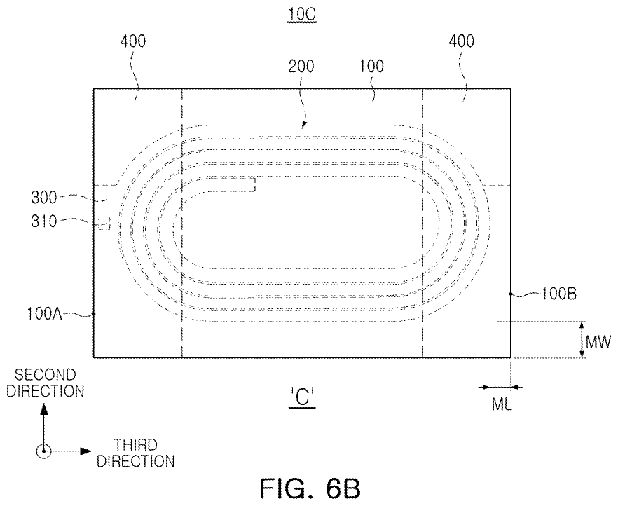

FIGS. 6A and 6B are views of FIGS. 4A and 4B, respectively, viewed from above (in the directions of B and C).

In the coil components 10B and 10C according to the present exemplary embodiment, a minimum distance M from the coil 200 to the first to fourth side surfaces 100A, 100B, 100C, and 100D of the body 100 may be 40 μm or more, but is not limited thereto.

A method of measuring the minimum distance M from the coil 200 to the first to fourth side surfaces 100A, 100B, 100C, and 100D of the body 100 is the same as described above.

By manufacturing the small and thin inductor as described above, a coil component that may be mounted on a substrate including a microcircuit pattern may be provided, and the incidence of defective products when manufacturing the small-sized inductor may also be reduced.

Other components are substantially the same as those described above, and thus, detailed descriptions thereof will be omitted.

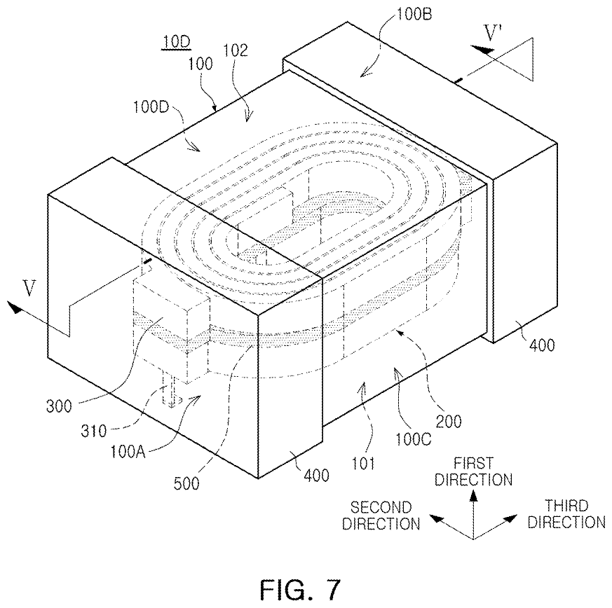

FIG. 7 is a view schematically illustrating a coil component 10D according to the present disclosure.

Referring to the drawings, the coil component 10D according to an exemplary embodiment in the present disclosure may include a body 100 including first to fourth side surfaces 100A, 100B, 100C, and 100D and one surface 101 and the other surface 102 connected to each of the first to fourth side surfaces 100A, 100B, 100C, and 100D and opposing each other in the first direction, a coil 200 disposed in the body 100, and a lead portion 300 disposed in the body 100, connected to the coil 200, and having at least a portion exposed to the first side surface 100A of the body.

In this case, the first and second side surfaces 100A and 100B of the body 100 may face each other, and the third and fourth side surfaces 100C and 100D may be disposed to face each other.

Also, the coil 200 may include a coil pattern 210 having at least one turn and an insulating layer 220 covering the coil pattern. In this case, the insulating layer 220 may function to insulate the body 100 and the coil 200 from each other, but the present disclosure is not limited thereto.

In addition, the coil component 10D according to the present exemplary embodiment may further include a substrate 500 disposed in the body 100 and allowing the coil 200 to be disposed on one surface thereof. The substrate 500 may be configured to support the coil 200, but is not limited thereto.

In this case, the coil 200 may be disposed on each of the upper and lower portions of the substrate 500, and a via penetrating through the substrate 500 to connect the coils of the upper and lower portions may be included, but is not limited thereto.

Referring to the drawings, the coil component 10D according to the present exemplary embodiment may further include an external electrode 400 disposed on at least a portion of the first and second side surfaces 100A and 100B of the body 100 opposing each other and having at least a portion extending to each of one surface 101 of the body and the other surface 102 opposing the one surface 101. In this case, at least a portion of the external electrode 400 disposed on at least a portion of the first and second side surfaces 100A and 100B of the body 100 may be in contact with the lead portion 300. In addition, when the substrate 500 supporting the coil 200 is disposed, the external electrode 400 may be further in contact with at least a portion of the substrate 500 exposed to at least a portion of the first and second side surfaces 100A and 100B of the body.

Also, although not shown, in the coil component 10D according to the present exemplary embodiment, an insulating film may be additionally disposed on each of the third and fourth side surfaces 100C and 100D of the body 100, but the present disclosure is not limited thereto.

In addition, in the coil component 10D according to the present exemplary embodiment, a distance T1 of the body 100 in the first direction may be formed to be 440 μm or less, a distance T3 of the coil 200 in the first direction may be formed to be less than a minimum distance T2 from one surface 101 of the body 100 to the coil 200 in the first direction, and a minimum distance M to the first to fourth side surfaces 100A, 100B, 100C, and 100D of the body 100 may be formed to have a value of 40 μm or greater, but the present disclosure is not limited thereto.

In addition, the coil component 10D according to this exemplary embodiment is formed so that the minimum distance T2 from the one surface 101 of the body to the coil 200 in the first direction has a value of 70 μm or greater, but the present disclosure is not limited thereto.

Other components are substantially the same as those described above, and thus, detailed descriptions thereof will be omitted.

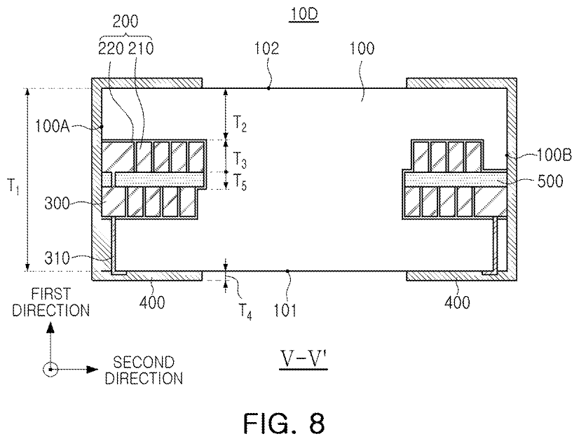

FIG. 8 is a view illustrating a cross-section taken along line V-V′ of FIG. 7.

Referring to the drawings, in the coil component 10D according to the present exemplary embodiment, the distance T1 in the first direction from one surface 101 to the other surface 102 of the body 100 opposing each other in the first direction may be 440 μm or less. That is, the thickness of the body 100 of the coil component 10D according to the present exemplary embodiment may be 440 μm or less, but is not limited thereto. In this case, the thickness of the body 100 may correspond to a thickness excluding the thickness of the external electrode 400 disposed on each of the first and other surfaces 101 and 102 of the body.

In addition, in the coil component 10D according to the present exemplary embodiment, the distance T3 of the coil 200 in the first direction may be less than the minimum distance T2 from one surface 101 of the body 100 to the coil 200 in the first direction. That is, a thickness of a cover portion, which is a thickness of the body covering the coil, may be thicker than the thickness of the coil 200 of the coil component 10B according to the present exemplary embodiment, but the present disclosure is not limited thereto. At this time, the minimum distance T2 from one surface 101 of the body to the coil 200 in the first direction, that is, the thickness of the cover portion, may be 70 μm or greater, but the present disclosure is not limited thereto.

In addition, in the coil component 10D according to the present exemplary embodiment, the distance T4 of the external electrode 400 disposed on each of one surface and the other surface 101 and 102 of the body in the first direction may be 60 μm or less. That is, the thickness of the external electrode 400 may be 60 μm or less, but is not limited thereto.

In addition, in the coil component 10D according to the present exemplary embodiment, the distance T5 of the substrate 500 in the first direction may be 20 μm or less. That is, the thickness of the substrate 500 may be 20 μm or less, but is not limited thereto.

A method of measuring each of the distance T1 from one surface 101 to the other surface 102 of the body 100 in the first direction, the minimum distance T2 from one surface 101 of the body 100 to the coil 200 in the first distance, the distance T3 of the coil 200 in the first direction, the distance T4 of the external electrode 400 disposed on one surface 101 of the body in the first direction, and the distance T5 of the substrate 500 in the first direction is as described above.

Other components are substantially the same as those described above, and thus, detailed descriptions thereof will be omitted.

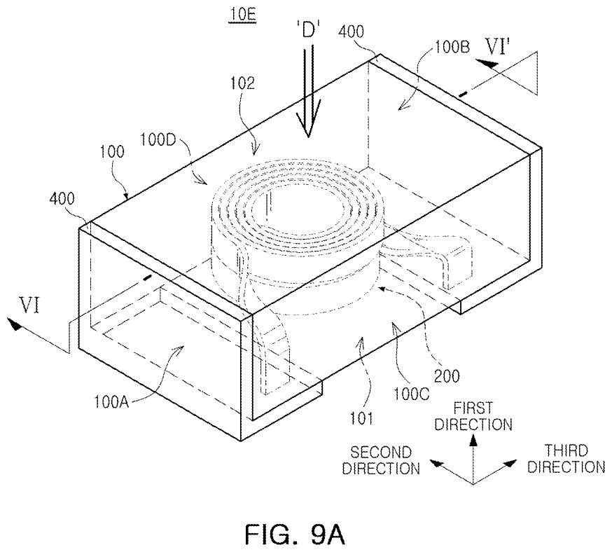

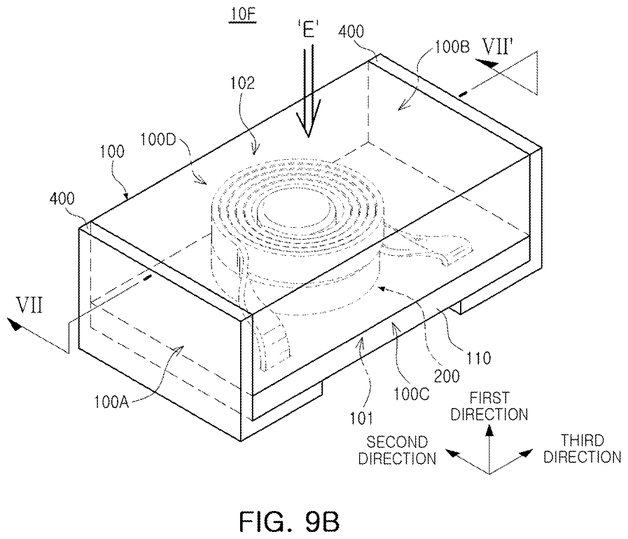

FIGS. 9A and 9B are views schematically illustrating coil components according to the present disclosure.

Referring to the drawings, the coil components 10E and 10F according to an exemplary embodiment in the present disclosure may include a body 100 including first to fourth side surfaces 100A, 100B, 100C, and 100D and one surface 101 and the other surface 102 connected to each of the first to fourth side surfaces 100A, 100B, 100C, and 100D and opposing each other in the first direction, a coil 200 disposed in the body 100, and a lead portion 300 disposed in the body 100, connected to the coil 200, and having at least a portion exposed to the first side surface 100A of the body.

In this case, the first and second side surfaces 100A and 100B of the body 100 may face each other, and the third and fourth side surfaces 100C and 100D may be disposed to face each other.

In addition, the coil 200 may include a winding type coil pattern covered with an insulating film, and in this case, the insulating film may function to insulate the body 100 and the coil 200 from each other, but the present disclosure is not limited thereto.

Referring to FIG. 9A, in the coil component 10E according to the present exemplary embodiment, the coil 200 may be embedded in the body 100 and may be spaced apart from each of the first to fourth side surfaces 100A, 100B, 100C, and 100D and one surface and the other surface 101 and 102, but the present disclosure is not limited thereto.

Referring to FIG. 9B, the body 100 of the coil component 10F according to the present exemplary embodiment may include a mold portion 110 in which the coil 200 is disposed on one surface thereof. In this case, the body 100 may include a cover portion disposed on the coil 200 and the mold portion 110.

The coil components 10E and 10F according to an exemplary embodiment in the present disclosure may include the lead portion 300 at least partially exposed to one surface 101 of the body 100. Also, the coil components 10E and 10F according to an exemplary embodiment in the present disclosure may further include an external electrode 400 disposed on at least a portion of the first and second side surfaces 100A and 100B of the body 100 opposing each other and having at least a portion extending to one surface 101 of the body. In this case, the external electrode 400 disposed on at least a portion of the first and second side surfaces 100A and 100B of the body 100 may be at least partially in contact with the lead portion 300 having at least a portion exposed to the one surface 101 of the body 100.

Also, although not shown, in the coil components 10E and 10F according to the present exemplary embodiment, an insulating film may be additionally disposed on each of the first to fourth side surfaces 100A, 100B, 100C, and 100D of the body 100, but the present disclosure is not limited thereto. That is, the external electrode 400 may be disposed only on one surface 101 of the body 100. In addition, when the external electrode 400 extends from one surface 101 of the body 100 to the first to fourth side surfaces 100A, 100B, 100C, and 100D, an insulating film may be additionally disposed on the first to fourth surfaces 100A, 100B, 100C, and 100D of the body 100, but the present disclosure is not limited thereto.

In this case, in the coil components 10E and 10F according to the present exemplary embodiment, the external electrodes 400 disposed on one surface 101 of the body 100 may include first and second external electrodes 400A and 400B spaced apart from each other on one surface 101 of the body.

In addition, in the coil components 10E and 10F according to the present exemplary embodiment, the distance T1 of the body 100 in the first direction may be 440 μm or less, the distance T3 of the coil 200 in the first direction is less than the minimum distance T2 from one surface 101 of the body 100 to the coil 200 in the first direction, and the minimum distance M to the first to fourth side surfaces 100A, 100B, 100C, and 100D of the body 100 or the margin of the coil component 10A according to the present exemplary embodiment may have a value of 40 μm or greater, but the present disclosure is not limited thereto.

In addition, in the coils 10E and 10F according to the present exemplary embodiment, the minimum distance T2 from one surface 101 of the body to the coil 200 in the first direction has a value of 70 μm or greater, but the present disclosure is not limited thereto.

Other components are substantially the same as those described above, and thus, detailed descriptions thereof will be omitted.

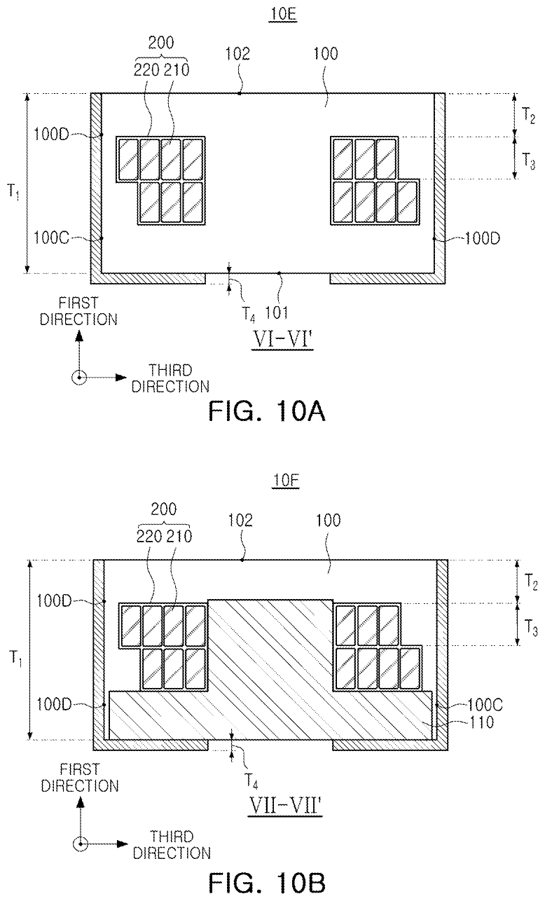

FIGS. 10A and 10B are views illustrating a cross-section taken along line V-V′ of FIG. 9A and a cross-section taken along line VI-VI′ of FIG. 9B, respectively.

Referring to the drawings, in the coil components 10E and 10F according to the present exemplary embodiment, the distance T1 from one surface 101 to the other surface 102 of the body in the first direction opposing each other in the first direction may be 440 μm or less. That is, a body thickness of the coil components 10E and 10F according to the present exemplary embodiment may be 440 μm or less, but is not limited thereto.

In addition, in the coils 10E and 10F according to the present exemplary embodiment, the distance T3 of the coil 200 in the first direction may be less than the minimum distance T2 from one surface 101 of the body 100 to the coil 200 in the first direction. That is, a thickness of a cover portion, which is a thickness of the body covering the coil, may be thicker than the thickness of the coil 200 of the coil components 10E and 10F according to the present exemplary embodiment, but the present disclosure is not limited thereto. At this time, the minimum distance T2 from one surface 101 of the body to the coil 200 in the first direction, that is, the thickness of the cover portion, may be 70 μm or greater, but the present disclosure is not limited thereto.

In addition, in the coil components 10E and 10F according to the present exemplary embodiment, a distance T4 of the external electrode 400 disposed on one surface 101 of the body in the first direction may be 60 μm or less. That is, the thickness of the external electrode 400 may be 60 μm or less, but is not limited thereto. In this case, the external electrode 400 may include first and second external electrodes 400A and 400B spaced apart from each other on one surface 101 of the body, and a distance or thickness of each of the first and second external electrodes 400A and 400B in the first direction may be 60 μm or less, but is not limited thereto.

A method of measuring each of the distance T1 from one surface 101 to the other surface 102 of the body 100 in the first direction, the minimum distance T2 from one surface 101 of the body 100 to the coil 200 in the first distance, the distance T3 of the coil 200 in the first direction, the distance T4 of the external electrode 400 disposed on one surface 101 of the body in the first direction, and the distance T5 of the substrate 500 in the first direction is as described above.

Other components are substantially the same as those described above, and thus, detailed descriptions thereof will be omitted.

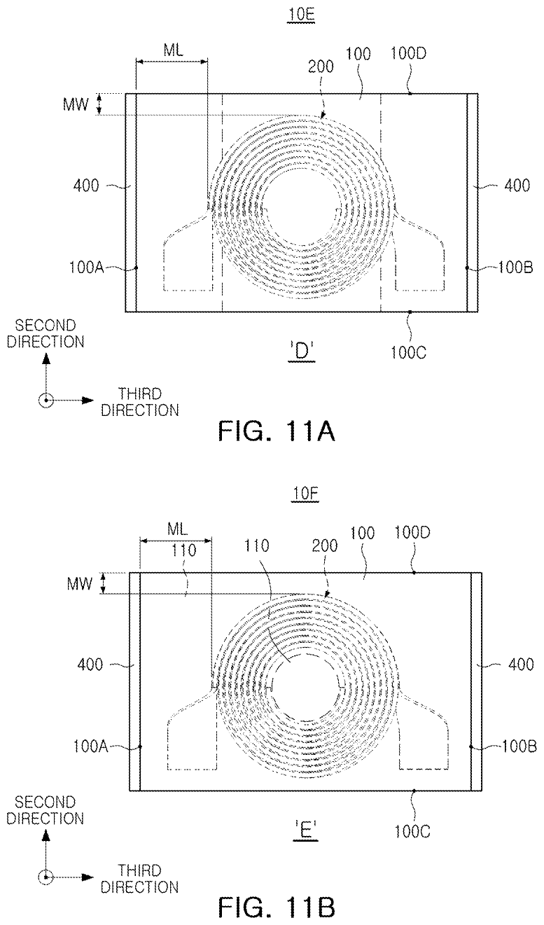

FIGS. 11A and 11B are views of FIGS. 9A and 9B, respectively, viewed from above (in the directions of D and E).

In the coil components 10E and 10F according to the present exemplary embodiment, a minimum distance M from the coil 200 to the first to fourth side surfaces 100A, 100B, 100C, and 100D of the body 100 may be 40 μm or greater, but is not limited thereto.

A method of measuring the minimum distance M from the coil 200 to the first to fourth side surfaces 100A, 100B, 100C, and 100D of the body 100 is the same as described above.

By manufacturing a small and thin inductor as described above, a coil component that may be mounted on a substrate including a microcircuit pattern may be provided and the incidence of defective products when manufacturing a small-sized inductor may also be reduced.

Other components are substantially the same as those described above, and thus, detailed descriptions thereof will be omitted.

As one effect among various effects of the present disclosure, the coil component that may be mounted on a substrate including a microcircuit pattern may be provided.

As another effect among the various effects of the present disclosure, a coil component capable of reducing the incidence of defective product may be provided.

The lengths, widths, thicknesses, distances, and dimensions disclosed herein may be obtained from an optical microscope (OM), a scanning electron microscope (SEM), a transmission electron microscope (TEM), or the like. However, the present disclosure is not limited thereto.

While exemplary embodiments have been shown and described above, it will be apparent to those skilled in the art that modifications and variations could be made without departing from the scope of the present disclosure as defined by the appended claims.

What is claimed is:

1. A coil component comprising:
a body including first to fourth side surfaces and one surface and the other surface connected to each of the first to fourth side surfaces and opposing each other in a first direction; and
a coil disposed in the body,
wherein a minimum distance from the coil to the first to fourth side surfaces of the body is 40 μm or greater.

2. The coil component of claim 1, wherein a distance from the one surface to the other surface of the body in the first direction is 440 μm or less.

3. The coil component of claim 1, wherein a thickness of the coil is less than a minimum distance from the one surface of the body to the coil in the first direction.

4. The coil component of claim 1, wherein a minimum distance from the one surface of the body to the coil in the first direction is 70 μm or greater.

5. The coil component of claim 1, wherein
a distance from the one surface to the other surface of the body in the first direction is 440 μm or less, and
a thickness of the coil in the first direction is less than a minimum distance from the one surface of the body to the coil.

6. The coil component of claim 5, wherein a minimum distance from the one surface of the body to the coil in the first direction is 70 μm or greater.

7. The coil component of claim 1, wherein the coil includes a coil pattern having at least one turn and an insulating layer covering the coil pattern.

8. The coil component of claim 1, further comprising:
external electrodes respectively disposed on the first and second side surfaces of the body opposing each other and extending to the one surface and the other surface of the body, respectively; and
a lead portion disposed in the body and extend from the first side surface of the body to connect the coil to each of the external electrodes.

9. The coil component of claim 1, further comprising external electrodes respectively disposed on the first and second side surfaces of the body opposing each other and having at least a portion extending to the one surface of the body.

10. The coil component of claim 1, further comprising:
first and second external electrodes disposed to be spaced apart from each other on one surface of the body; and
a lead portion disposed in the body and connecting the coil to each of the first and second external electrodes.

11. The coil component of claim 10, wherein the lead portion includes a connection portion connected to each of the first and second external electrodes.

12. The coil component of claim 1, further comprising a substrate disposed in the body and allowing the coil to be disposed on one surface thereof.

13. The coil component of claim 12, wherein
a distance from the one surface and the other surface of the body in the first direction is 440 μm or less, and
a thickness of the coil is less than a minimum distance from the one surface of the body to the coil in the first direction.

14. The coil component of claim 12, wherein the minimum distance from the one surface of the body to the coil in the first direction is 70 μm or greater.

15. The coil component of claim 12, further comprising:
a lead portion disposed in the body, connected to the coil, and extending from the first side surface of the body,
wherein the coil includes a coil pattern having at least one turn and an insulating layer covering each of the coil pattern and the lead portion.

16. The coil component of claim 12, further comprising external electrodes respectively disposed on the first and second side surfaces of the body opposing each other.

17. The coil component of claim 1, wherein the coil is a winding-type coil.

18. the coil component of claim 17, wherein the body includes a mold portion in which the coil is disposed on one surface thereof.

19. The coil component of claim 17, wherein
a distance from the one surface to the other surface of the body in the first direction is 440 μm or less, and
a thickness of the coil in the first direction is less than a minimum distance from the one surface of the body to the coil.

20. The coil component of claim 17, further comprising first and second external electrodes disposed to be spaced apart from each other on one surface of the body.

21. The coil component of claim 1, further comprising a substrate disposed in the body, wherein the substrate includes a reinforcing material, and the coil is disposed on one surface of the substrate.

22. The coil component of claim 21, wherein the reinforcing material includes a glass fiber or an inorganic filler.

23. The coil component of claim 22, wherein the inorganic filler includes at least one selected from the group consisting of silica, alumina, silicon carbide, barium sulfate, talc, mud, mica powder, aluminum hydroxide, magnesium hydroxide, calcium carbonate, magnesium carbonate, magnesium oxide, boron nitride, aluminum borate, barium titanate, and calcium zirconate.
